(19) United States
(12) Patent Application Publication
(10) Pub. No.: US 2026/0274708 A1
(43) Pub. Date: Sep. 17, 2026

(54) PARTICULATE, WATER-INSOLUBLE INORGANIC MATERIAL PROVIDED WITH SILVER OXIDE AND RUTHENIUM OXIDE

(71) Applicant: HERAEUS PRECIOUS METALS GMBH & CO. KG, Hanau (DE)

(72) Inventors: Milena KOVJENIC, Hanau (DE); Ana-Lucia MEZA-CHINCHA, Hanau (DE); Marie-Lena HARWARDT, Hanau (DE); Michael GOCK, Hanau (DE); Matthias HÖRTEIS, Hanau (DE)

(21) Appl. No.: 19/168,165

(22) PCT Filed: Feb. 1, 2024
(86) PCT No.: PCT/EP2024/052486

§ 371 Date: Sep. 23, 2025

(30) Foreign Application Priority Data
Mar. 28, 2023 (EP) 23164575.5

(51) Int. Cl. C01G 55/00; C01G 5/00

(52) U.S. Cl. CPC C01G 55/004; C01G 5/00; C01P 2004/61; C01P 2006/12

(57) ABSTRACT

Particulate, water-insoluble inorganic material provided with silver oxide and ruthenium oxide, and method for its production by drying and thermolytic treatment, which is carried out in a non-reducing atmosphere, of a preparation that contains water, particles of water-insoluble inorganic material, at least one silver oxide precursor and at least one ruthenium oxide precursor.

### DESCRIPTION

The invention relates to a particulate, water-insoluble inorganic material provided with the noble metal oxides silver oxide and ruthenium oxide, as well as to an efficient method for its production.

The object of the invention was to provide a new antimicrobial material that can be produced simply and efficiently.

The problem can be solved by providing a product in the form of a particulate, water-insoluble inorganic material provided with silver oxide (Ag₂O) and ruthenium oxide (RuO₂). To avoid any misunderstanding, the term “water-insoluble” used in this context is not to be understood in an absolute sense, but rather it refers to water insolubility in the practical sense, i.e., a water solubility of, for example, less than 0.01 g per liter of water at 20° C. The water-insoluble inorganic material (the water-insoluble inorganic material as such) is a refractory, i.e., high-melting material, i.e., a material that does not melt at application temperatures of the product according to the invention, for example at temperatures lower than 1000° C. The water-insoluble inorganic material (the water-insoluble inorganic material as such) is preferably selected from the group consisting of aluminum nitride, titanium nitride, silicon nitride, corundum, anatase titanium dioxide, rutile titanium dioxide, pyrogenic silica, precipitated silica, sodium aluminum silicate, zirconium silicate, zeolite, hydrotalcite and gamma-aluminum oxyhydroxide.

The particulate, water-insoluble inorganic material according to the invention, which is provided with silver oxide and ruthenium oxide, is hereinafter also referred to simply as “product according to the invention”. Its silver-plus-ruthenium weight proportion formed by the silver oxide and ruthenium oxide can, for example, be in the range of 0.1 to 50 wt. % (% by weight), preferably 1 to 40 wt. %, at a simultaneously prevailing silver: ruthenium weight ratio in the range of 1 to 2000 parts by weight of silver: 1 part by weight of ruthenium, for example.

The particulate, water-insoluble inorganic material or the particles of the water-insoluble inorganic material as such are a carrier material (carrier particles) for the silver oxide and the ruthenium oxide that is free of noble metal oxide per se, i.e., in the product according to the invention the particulate, water-insoluble inorganic material functions as a carrier for the silver oxide and the ruthenium oxide. The product according to the invention may comprise one or more types of carrier material; usually and also preferably only one type of carrier material is present in the product according to the invention.

The product according to the invention can have an average particle size (d50), for example, in the range of 0.3 to 100 μm and a BET surface area, for example, in the range of 1 to 2000 m²/g. It may also have a pore volume, for example, in the range of 0.5 to 10 mL/g.

The term “average particle size” used herein means the volume-average primary particle diameter (d50) determinable by means of laser diffraction. In this case, what is known as Equivalent Circular Area Diameter (ECAD) can advantageously be used as a measure of the particle diameter (cf. RENLIANG XU ET AL: “Comparison of sizing small particles using different technologies,” POWDER TECHNOLOGY, ELSEVIER, BASEL (CH), vol. 132, no. 2-3, Jun. 24, 2003(06 -24-2003), pages 145-153). Laser diffraction measurements can be carried out using a corresponding particle size measuring instrument, for example a Mastersizer 3000 or Mastersizer 2000 from Malvern Instruments according to the wet determination process. In the wet determination process, a particulate sample can be dispersed in ethanol by means of ultrasound as part of the preparation of the sample.

The term “BET surface area” used herein refers to the specific surface area that can be determined by means of BET measurement according to DIN ISO 9277:2014-01 (according to chapter 6.3.1, static-volumetric measurement method, gas used: nitrogen).

The term “pore volume” is used herein. The pore volume can be determined by means of mercury porosimetry according to DIN ISO 15901-1: 2016 (sample mass 30 mg; surface tension of mercury 0.48 N/m; contact angle of mercury 141.3°; instrument: Porotec Pascal 140+440; measurement method: scanning; start filling pressure 0.0128 MPa; dilatometer: powder, small volume; sample preparation: 8 h at 110° C. under vacuum).

The product according to the invention comprises the particles of water-insoluble inorganic material provided with silver oxide and ruthenium oxide in a proportion, for example, in the range of 90 to 100 wt. % or 95 to 100 wt. %, in particular 100 wt. %. The possible proportion, which however does not amount to more than 10 wt. % or more than 5 wt. %, can be formed by corresponding noble metal oxide-free particles of the water-insoluble inorganic material, ruthenium oxide particles and/or silver oxide particles. In other words, the product according to the invention can consist of 90 to 100 wt. % or 95 to 100 wt. % of particles of the water-insoluble inorganic material provided with silver oxide and ruthenium oxide and 0 to 10 wt. % or 0 to 5 wt. % of corresponding noble metal oxide-free particles of the water-insoluble inorganic material, ruthenium oxide particles and/or silver oxide particles, the particular wt. % adding up to 100 wt. %. Apart from the particles of the water-insoluble inorganic material provided with silver oxide and ruthenium oxide, and the components making up 0 to 10 wt. % and 0 to 5 wt. % respectively, the product according to the invention does not comprise any other deliberately added material or substances.

The silver oxide and the ruthenium oxide can be present on inner surfaces (within pores and/or cavities) and/or on the outer surface of the carrier particles of the water-soluble inorganic material and can thereby form, for example, a discontinuous layer and/or small silver oxide or ruthenium oxide particles (silver oxide or ruthenium oxide islands). Scanning and transmission electron microscopy may be a suitable method for observing such morphological properties. The silver oxide and the ruthenium oxide are statistically distributed, and both noble metal oxides are at least partially in contact with one another. It is clear to a person skilled in the art that the silver oxide and the ruthenium oxide of the product according to the invention can also comprise, to a small, practically negligible extent, other silver forms (silver species) and other ruthenium forms (ruthenium species), for example elemental metallic silver or elemental metallic ruthenium and/or silver(I) compounds other than silver oxide or ruthenium compounds other than ruthenium oxide, for example halides and/or sulfides. Such forms can be produced unintentionally and inevitably as minor impurities during or subsequent to production, for example during storage, use or further processing of the product according to the invention.

The invention also relates to a method for producing the product according to the invention. From another perspective, the method can also be understood as a method for providing a corresponding particulate, water-insoluble inorganic material with silver oxide and ruthenium oxide.

In the method according to the invention, the product according to the invention can be obtained in the course of drying and thermolytic treatment, which is carried out in a non-reducing atmosphere, of a preparation that contains water, particles of a corresponding water-insoluble inorganic material as mentioned above, at least one silver oxide precursor and at least one ruthenium oxide precursor. Thermolytic treatment is a treatment at or above the thermolysis temperature. The thermolysis temperature is the minimum object temperature which ensures thermal decomposition of the at least one silver oxide precursor and the at least one ruthenium oxide precursor in a non-reducing atmosphere to form silver oxide and ruthenium oxide.

The term “non-reducing atmosphere” as used herein refers to an oxidizing or inert atmosphere. The term “oxidizing atmosphere” refers to an atmosphere consisting of a gas that has oxidizing properties, such as oxygen, air or a gas mixture of oxygen and one or more inert gases such as nitrogen, argon and/or carbon dioxide; the volume fraction of oxygen within such a gas mixture with inert gas can, for example, be in the range of 10 to 30 vol. %. The term “inert atmosphere” refers to an atmosphere consisting of one or more inert gases such as nitrogen, argon and/or carbon dioxide.

In the method according to the invention, the above-mentioned particles of water-insoluble inorganic material (i.e., of a corresponding water-insoluble inorganic material), silver oxide precursor and ruthenium oxide precursor are used.

As already mentioned, the aforementioned particles of the water-insoluble inorganic material are particles of which the material as such is preferably selected from the group consisting of aluminum nitride, titanium nitride, silicon nitride, corundum, anatase titanium dioxide, rutile titanium dioxide, pyrogenic silicon dioxide, precipitated silicon dioxide, sodium aluminum silicate, zirconium silicate, zeolite, hydrotalcite and gamma-aluminum oxyhydroxide. In other words, the particles consist of a material selected from the group consisting of aluminum nitride, titanium nitride, silicon nitride, corundum, anatase titanium dioxide, rutile titanium dioxide, pyrogenic silica, precipitated silica, sodium aluminum silicate, zirconium silicate, zeolite, hydrotalcite and gamma-aluminum oxyhydroxide. Preference is given to corresponding particles of titanium nitride, corundum, anatase or rutile titanium dioxide, pyrogenic or precipitated silica and gamma-aluminum oxyhydroxide.

Preferably, the aforementioned particles of the water-insoluble inorganic material have an average particle size (d50) in the range of 0.3 μm to 40 μm and a BET surface area in the range of 1 to 2000 m²/g. They can also have a pore volume in the range of 0.5 to 10 mL/g.

The silver oxide precursors and the ruthenium oxide precursors used in the method according to the invention are silver and ruthenium compounds, respectively, which can be thermally decomposed to form silver oxide and ruthenium oxide, respectively, in a non-reducing atmosphere.

All silver compounds which can be thermally decomposed to form silver oxide in a non-reducing atmosphere can be thermolytically treated in the method according to the invention in an oxidizing atmosphere and in the method be thermally decomposed to form silver oxide. A person skilled in the art can easily determine such suitability of a silver compound for thermal decomposition to form silver oxide in an oxidizing atmosphere, for example using thermogravimetry in an oxidizing atmosphere. Examples of silver compounds suitable as silver oxide precursors in this context include silver acetate and silver nitrate.

Some silver compounds which can be thermally decomposed to form silver oxide in a non-reducing atmosphere can be thermolytically treated in the method according to the invention even in an inert atmosphere and in the method be thermally decomposed to form silver oxide. A person skilled in the art can easily determine such suitability of a silver compound for thermal decomposition to form silver oxide in an inert atmosphere, for example using thermogravimetry in an inert gas atmosphere. An example of a silver compound suitable as a silver oxide precursor in this context is silver nitrate.

All ruthenium compounds which can be thermally decomposed to form ruthenium oxide in a non-reducing atmosphere can be thermolytically treated in the method according to the invention in an oxidizing atmosphere and in the method be thermally decomposed to form ruthenium oxide. A person skilled in the art can easily determine such suitability of a ruthenium compound for thermal decomposition to form ruthenium oxide in an oxidizing atmosphere, for example using thermogravimetry in an oxidizing atmosphere. Examples of ruthenium compounds which are suitable in this context include ruthenium nitrosyl nitrate, ruthenium oxalate, ruthenium acetate and in particular ruthenium nitrosyl oxalate.

Some ruthenium compounds which can be thermally decomposed to form ruthenium oxide in a non-reducing atmosphere can be thermolytically treated in the method according to the invention even in an inert atmosphere and in the method be thermally decomposed to form ruthenium oxide. A person skilled in the art can easily determine such suitability of a ruthenium compound for thermal decomposition to form ruthenium oxide in an inert atmosphere, for example using thermogravimetry in an inert gas atmosphere. Examples of ruthenium compounds suitable as ruthenium oxide precursors in this context include ruthenium nitrosyl nitrate, ruthenium oxalate and in particular ruthenium nitrosyl oxalate.

For example, in the method according to the invention, a combination of silver nitrate and ruthenium nitrosyl oxalate or ruthenium nitrosyl nitrate can be used and preferably thermolytically treated in an oxidizing atmosphere.

The production method according to the invention includes successively providing a preparation that contains water, particles of the water-insoluble inorganic material, at least one silver oxide precursor and at least one ruthenium oxide precursor, and drying and thermolytic treatment of the preparation, which is carried out in a non-reducing atmosphere. Drying and thermolytic treatment can be carried out sequentially or as a joint step.

In a first embodiment, the method according to the invention comprises the successive steps of:
(1) providing a preparation that contains water, particles of the water-insoluble inorganic material, at least one silver oxide precursor and at least one ruthenium oxide precursor,
(2) drying the preparation provided in step (1), and
(3) thermolytically treating the dried preparation obtained after completion of step (2), which is carried out in a non-reducing atmosphere.

In a second embodiment of steps (2) and (3) carried out jointly, the method according to the invention comprises the successive steps of:
(1) providing a preparation that contains water, particles of the water-insoluble inorganic material, at least one silver oxide precursor and at least one ruthenium oxide precursor, and
(2+3) drying and thermolytically treating the preparation provided in step (1) in a non-reducing atmosphere.

In step (1) according to both embodiments of the method according to the invention, a preparation is provided which contains water, particles of the water-insoluble inorganic material, at least one silver oxide precursor and at least one ruthenium oxide precursor. The preparation may be in the form of an aqueous suspension or in the form of impregnated particles. The two forms (a) aqueous suspension versus (b) impregnated particles respectively differ in the presence or absence of aqueous liquid between the particles; while in the case of an aqueous suspension there is an aqueous liquid between the particles, this is not the case with impregnated particles which have the appearance of a dry or freely flowable powder and the aqueous liquid forms a component of the particles or is within the particles.

The aqueous suspension can be prepared by adding particles of the water-insoluble inorganic material to an aqueous solution of the at least one silver oxide precursor and of the at least one ruthenium oxide precursor and suspending them therein.

However, it is preferred to work in such a way that silver oxide precursor and ruthenium oxide precursor, preferably in each case as an aqueous solution, are added simultaneously or in any order (overlapping with a time delay, alternating or successively) to an initially charged aqueous suspension of particles of the water-insoluble inorganic material. It is particularly preferred that an aqueous solution of both noble metal precursors (of the at least one silver oxide precursor and of the at least one ruthenium oxide precursor) is added to an initially charged aqueous suspension of particles of the water-insoluble inorganic material. In general, mixing is carried out during and also after the addition, for example by means of stirring.

The weight proportion of the particles of the water-insoluble inorganic material in the aqueous suspension provided in step (1) of the method according to the invention can be, for example, in the range of 5 to 30 wt. %.

The weight proportion of noble metal formed from silver and ruthenium in the aqueous suspension provided in step (1) of the method according to the invention can be, for example, in the range of 1 to 20 wt. %. The aqueous suspension provided in step (1) of the method according to the invention is characterized by a weight ratio of the two noble metals, for example, in the range of 1 to 2000 parts by weight of silver: 1 part by weight of ruthenium and generally significantly in favor of the silver.

In addition to the particles of the water-insoluble inorganic material, the silver oxide precursor(s) and the ruthenium oxide precursor(s), the aqueous suspension provided in step (1) of the method according to the invention generally only comprises water and optionally a corresponding acid from the noble metal oxide precursors.

Producing the preparation in the form of impregnated particles is preferred. It can be carried out by impregnating the particles of the water-insoluble inorganic material with an aqueous solution of the at least one silver oxide precursor and the at least one ruthenium oxide precursor in a manner customary in the art. The impregnation process can be carried out once or repeatedly, in the latter case with a drying step taking place between the individual impregnation steps.

The impregnation process must be carried out in such a way that no aqueous suspension, i.e., neither a thin slurry nor a pulpy, pasty or doughy mass, is created, but rather impregnated particles are formed in the form of a macroscopically homogeneous and freely flowable powder. In other words, the volume of aqueous solution must be chosen to be sufficiently small and suitable for the particles of the water-insoluble inorganic material to be impregnated with it. When carrying out the impregnation, it is appropriate to allow sufficient time for the particles of the water-insoluble inorganic material and the aqueous solution to mix. For example, it may be appropriate to mix for a sufficiently long time, in particular until the macroscopically homogeneous state of the mixed material is achieved. The volume of the aqueous solution can be selected by adjusting the particular concentration of the noble metal oxide precursors to the number of particles of the water-insoluble inorganic material to be brought into contact with it and their absorption behavior for the aqueous solution. If the volume is too large, the aforementioned undesirable slurries, pulps, doughs or pastes are created. A person skilled in the art can easily determine the absorption behavior of the relevant particles of a water-insoluble inorganic material for a relevant aqueous solution in orientating laboratory tests and thus determine the upper limit in liters of aqueous solution per kilogram of particles of the water-insoluble inorganic material without any loss of the free flowability occurring.

The weight proportion of the particles of the water-insoluble inorganic material in the impregnated particles provided in step (1) of the method according to the invention can be, for example, in the range of 50 to 90 wt. %.

The weight proportion of noble metal formed from silver and ruthenium in the impregnated particles provided in step (1) of the method according to the invention can be, for example, in the range of 3 to 20 wt. %. The impregnated particles provided in step (1) of the method according to the invention are characterized by a weight ratio of the two noble metals for example in the range of 1 to 2000 parts by weight of silver: 1 part by weight of ruthenium and generally significantly in favor of the silver.

In addition to the particles of the water-insoluble inorganic material and the noble metal oxide precursors, the impregnated particles provided in step (1) of the method according to the invention generally only comprise water and optionally a corresponding acid from the noble metal oxide precursors. The water content of the impregnated particles provided in step (1) of the method according to the invention can, for example, be in the range of 7 to 35 wt. %.

In step (2) according to the first embodiment of the method according to the invention, the preparation provided in step (1) is dried, i.e., water and any other volatile substances optionally present are removed.

In the case of the aqueous suspension, it is evaporated to dryness. Advantageously, the aqueous suspension is agitated during concentration, for example by stirring and/or shaking and/or rotation, i.e., rotation of the vessel or container containing the aqueous suspension. In general, heating and/or negative pressure are applied during concentration to remove water and any other volatile substances that may be present. During concentration, work can be carried out at a temperature in the range of 40 to 110° C., for example. The material obtained after dryness has been achieved can be comminuted if necessary.

In the case of impregnated particles, these can be dried in a furnace at a temperature in the range of 40 to 110° C., for example. Negative pressure can be applied to assist this. The dried material can be comminuted if necessary.

In step (3) according to the first embodiment of the method according to the invention, the noble metal oxide precursors are thermally decomposed to form silver oxide and ruthenium oxide. For this purpose, the optionally comminuted material obtained after completion of step (2) is subjected to a thermolytic treatment in a non-reducing atmosphere. For this purpose, the material can be heated, either not in motion or in motion, to a thermolysis temperature, for example in the range of 120 to 900° C., preferably 150 to 400° C., for example in a static furnace, a fluidized-bed reactor or a rotary kiln. During step (3), the furnace chamber is expediently flushed with the non-reducing gas or gas mixture; the gas flow can also serve to remove gaseous decomposition products. The non-reducing atmosphere can also be pressure-reduced.

In the combined step (2+3) according to a first variant of the second embodiment of the method according to the invention, the preparation provided in step (1) is dried and thermolytically treated in a non-reducing atmosphere. The preparation provided in step (1) can pass through, either in motion or not in motion, a temperature profile comprising a drying temperature and a higher thermolysis temperature within a furnace. This can be achieved by passage through a furnace with a temperature gradient comprising a drying temperature and a thermolysis temperature or by working in a furnace with a time-controlled heating or temperature program, which ensures a drying temperature first and then a thermolysis temperature. Examples of usable furnace types include static furnaces, fluidized-bed reactors and rotary kilns. Work can be carried out with the preparation provided in step (1) in the form of an aqueous suspension, but it is preferred for work to be carried out with the preparation provided in step (1) in the form of impregnated particles.

In any case, the preparation provided in step (1) is first dried, i.e., water and any other volatile substances optionally present are removed. In the case of the preparation provided in step (1) as an aqueous suspension, it is evaporated to dryness. During concentration, work can be carried out at a drying temperature in the range of 40 to 110° C., for example. In the case of the preparation provided in step (1) in the form of impregnated particles, these can also be dried at a drying temperature, for example in the range of 40 to 110° C. After drying is complete, the noble metal oxide precursors are thermally decomposed to form silver oxide and ruthenium oxide by immediately being heated further to the thermolysis temperature without intermediate cooling, for example in the range of 120 to 900° C., preferably 150 to 400° C. i.e., the dried material is subjected to a thermolytic treatment. This drying, as well as the thermolysis immediately thereafter, take place in a non-reducing atmosphere.

Also in the combined step (2+3) according to a second variant of the second embodiment of the method according to the invention, the preparation provided in step (1) is dried and thermolytically treated in a non-reducing atmosphere. The preparation provided in step (1) can be exposed, in motion or not in motion, to the thermolysis temperature, for example in the range of 120 to 900° C., preferably 150 to 400° C., within a furnace. Examples of usable furnace types include static furnaces, fluidized-bed reactors and rotary kilns. Work can be carried out with the preparation provided in step (1) in the form of an aqueous suspension, but it is preferred for work to be carried out with the preparation provided in step (1) in the form of impregnated particles. The noble metal oxide precursors are thermally decomposed to form silver oxide and ruthenium oxide. Drying and thermolysis occur practically in parallel. Work is carried out in a non-reducing atmosphere.

After completion of step (3) according to the first embodiment or of step (2+3) according to both variants of the second embodiment of the method according to the invention and optionally subsequent comminution and/or classification, the product according to the invention is obtained.

The product according to the invention, i.e., the particulate, water-insoluble inorganic material provided with silver oxide and ruthenium oxide is characterized by a dark or black color with a correspondingly low brightness L*, for example in the range of 35 to 45, which can be disturbing for some applications. The brightness L* is a specific L* in the CIEL*a*b* color space (DIN EN ISO/CIE 11664-4:2020-03) determined by spectrophotometry at a measurement geometry of d/8°; the spectrophotometric measurement of the product according to the invention can be performed on a sample poured into a colorless glass vessel to a filling height of 1 cm through the flat glass bottom of the glass vessel placed on the measuring head of the spectral photometer used.

If desired, the product according to the invention can be further processed into a brightened particulate material with a brightness L*, for example in the range of 50 to 85. For brightening purposes, the product according to the invention can be brought into contact with at least one C1-C4 alkoxide of aluminum, magnesium, calcium, silicon, zinc, zirconium, and/or titanium in the presence of an amount of water that is at least sufficient for complete hydrolysis of the at least one C1-C4 alkoxide. As stated, a brightened particulate material, i.e., a particulate material with a color, for example a gray color, with a brightness L* in the range of, for example, 50 to 85 can be formed. This brightened particulate material consists of the product according to the invention with at least a portion of a solid thereon. Depending on the selection of the at least one C1-C4 alkoxide, the solid is a solid selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium(IV) oxyhydrates, titanium dioxide, titanium(IV) oxyhydrates and combinations thereof.

The product according to the invention, optionally brightened as mentioned above, is characterized by a particularly strong antimicrobial effect, as can be determined in conventional inhibition zone tests or by determining the minimum inhibitory concentration from growth curves of microorganisms. In this respect, the invention also relates to the use of the optionally brightened product according to the invention provided as an additive for the antimicrobial treatment of metal surfaces; coating agents such as varnishes and other paints; plasters; molding compounds; plastics materials in the form of plastics films, plastics parts, or plastics fibers; textiles or textile applications; synthetic resin products; ion-exchange resins; silicone products; cellulose-based products; foams; cosmetics; and many others.

The product according to the invention, optionally brightened as mentioned above, can also be used as a heterogeneous catalyst, for example in the catalysis of the formation of hydroxyl radicals in aqueous media permitting bacterial growth.

The product according to the invention, optionally brightened as mentioned above, can be used as a dry powder for the above-mentioned applications. If appropriate or desired, it can be previously adjusted to a desired moisture content with water or converted into an aqueous suspension.

### EXAMPLES

### Reference Example 1 (Thermolytic Preparation of a Particulate, Inorganic Material Provided with 20.7 wt. % of Elemental Silver and 1.3 wt. % of Elemental Ruthenium)

An aqueous solution prepared from 52.4 g of aqueous silver nitrate solution (silver content 36.2 wt. %; 176.2 mmol Ag) and 5.3 g of aqueous ruthenium nitrosyl nitrate solution (ruthenium content 18.9 wt. %; 9.8 mmol Ru) was added to 80 g of zeolite powder (beta zeolites-SAR 40 from PIDC) while shaking. The material was then dried in a drying furnace at 105° C./300 mbar. The material was then calcined in a tube furnace for 5 hours in a forming gas atmosphere (5 vol. % hydrogen/95 vol. % nitrogen) at 250° C. and comminuted with an agate mortar. Using ICP-OES (inductively coupled plasma optical emission spectrometry), a silver content of 20.7 wt. % and a ruthenium content of 1.3 wt. % of the product (each based on 0 wt. % residual moisture) were determined. Using XRD (X-ray diffraction), the silver and ruthenium contained in the product were each confirmed as elemental metals.

### Example 2 According to the Invention (Thermolytic Preparation of a Particulate, Inorganic Material Provided with 19 wt. % Silver in the Form of Silver Oxide and 1 wt. % Ruthenium in the Form of Ruthenium Oxide)

An aqueous solution prepared from 26.2 g of aqueous silver nitrate solution (silver content 36.2 wt. %; 88.1 mmol Ag) and 2.6 g of aqueous ruthenium nitrosyl nitrate solution (ruthenium content 18.9 wt. %; 4.9 mmol Ru) and 3.2 g water was added to 40 g of zeolite powder (Puralox TM100/150 UF from Sasol) while shaking. The material was then dried in the drying furnace at 105° C./300 mbar for 5 hours. The material was then calcined at 250° C. in a tube furnace for 16 hours in an air atmosphere and comminuted with an agate mortar. A silver content of 18.7 wt. % and a ruthenium content of 1.0 wt. % of the product (relative to 0 wt. % residual moisture) was determined by means of ICP-OES. Using XPS (X-ray photoelectron spectroscopy), the silver and ruthenium contained in the product were each confirmed to be the corresponding metal oxide.

### Example 3 (Test of the Products from Reference Example 1 and Example 2 According to the Invention to Compare Their Antimicrobial Effect)

The antimicrobial effect can be analyzed chemically, among other things. The chemical analysis includes the determination of the concentration of hydrogen peroxide and other reactive oxygen forms produced by the products in the presence of oxygen and water using UV/VIS spectroscopy.

The product to be analyzed is incubated in an acidic aqueous solution of iron(II) ions and the dye xylenol orange. The reaction with the reactive oxygen forms formed in situ produces iron(III) ions, which form a violet complex with the organic dye. The amount of radicals produced in μg/L can be determined by photometric determination of the concentration of the complex in solution. In order to determine the radical concentration as accurately as possible, multiple dilutions of a hydrogen peroxide stock solution are analyzed analogously on the day of the analysis and a calibration curve is created.

For the specific analysis, 50 mg of the product to be analyzed, 2.5 mL of an acidic 4 mM ammonium iron(II) sulfate solution and 0.5 mL of a 2.7 mM solution of xylenol orange were placed in a volumetric flask. The sample was made up to 50 mL by the addition of distilled water and stirred for 55 min at room temperature and 450 rpm. After a sedimentation time of five minutes, a sample of the supernatant solution was filtered and the absorbance at 585 nm was determined. Using the calibration curve, the absorbance of the sample was converted into the concentration of hydrogen peroxide.

The corresponding sample amount of the product from Reference Example 1 or Example 2 according to the invention was used to calculate the radical concentration. This resulted in a value for the product from Reference Example 1 of 1157 μg/L and a comparable value for the product from Example 2 according to the invention of 951 μg/L.

1. A particulate, water-insoluble inorganic material provided with silver oxide and ruthenium oxide.

2. The particulate, water-insoluble inorganic material provided with silver oxide and ruthenium oxide according to claim 1, wherein the water-insoluble inorganic material is selected from the group consisting of aluminum nitride, titanium nitride, silicon nitride, corundum, anatase titanium dioxide, rutile titanium dioxide, pyrogenic silica, precipitated silica, sodium aluminum silicate, zirconium silicate, zeolite, hydrotalcite and gamma-aluminum oxyhydroxide.

3. The particulate, water-insoluble inorganic material provided with silver oxide and ruthenium oxide according to claim 1, wherein its silver-plus-ruthenium weight proportion formed by the silver oxide and ruthenium oxide is in the range of 0.1 to 50 wt. % at a simultaneously prevailing silver:ruthenium weight ratio in the range of 1 to 2000 parts by weight of silver:1 part by weight of ruthenium.

4. The particulate, water-insoluble inorganic material provided with silver oxide and ruthenium oxide according to claim 1, which has an average particle size (d50) in the range of 0.3 to 100 μm and a BET surface area in the range of 1 to 2000 m²/g.

5. The particulate, water-insoluble inorganic material provided with silver oxide and ruthenium oxide according to claim 1, consisting of 90 to 100 wt. % of particles of the water-insoluble inorganic material provided with silver oxide and ruthenium oxide and 0 to 10 wt. % of corresponding noble metal oxide-free particles of the water-insoluble inorganic material, ruthenium oxide particles and/or silver oxide particles.

6. A method for producing a particulate, water-insoluble inorganic material provided with silver oxide and ruthenium oxide according to claim 1, by drying and thermolytic treatment, which is carried out in a non-reducing atmosphere, of a preparation that contains water, particles of a corresponding water-insoluble inorganic material, at least one silver oxide precursor and at least one ruthenium oxide precursor.

7. The method according to claim 6, wherein the non-reducing atmosphere is an oxidizing or inert atmosphere.

8. The method according to claim 6, wherein the silver oxide precursors and ruthenium oxide precursors are silver and ruthenium compounds, respectively, which can be thermally decomposed to form silver oxide and ruthenium oxide, respectively, in a non-reducing atmosphere.

9. The method according to claim 6, wherein the non-reducing atmosphere is an oxidizing atmosphere, wherein the at least one silver oxide precursor is selected from the group consisting of silver acetate and silver nitrate, and wherein the at least one ruthenium oxide precursor is selected from the group consisting of ruthenium nitrosyl nitrate, ruthenium oxalate, ruthenium acetate and ruthenium nitrosyl oxalate.

10. The method according to claim 6, wherein the non-reducing atmosphere is an inert atmosphere, wherein the at least one silver oxide precursor is silver nitrate and wherein the at least one ruthenium oxide precursor is selected from the group consisting of ruthenium nitrosyl nitrate, ruthenium oxalate, and ruthenium nitrosyl oxalate.

11. The method according to claim 6, comprising the successive steps of:
(1) providing the preparation,
(2) drying the preparation provided in step (1), and
(3) thermolytically treating the dried preparation obtained after completion of step (2) in a non-reducing atmosphere,
or comprising the successive steps of:
(1) providing the preparation, and
(2+3) drying and thermolytically treating the preparation provided in step (1) in a non-reducing atmosphere.

12. The method according to claim 6, wherein the preparation is an aqueous suspension or impregnated particles.

13. The method according to claim 6, wherein the thermolytic treatment is carried out at a thermolysis temperature in the range of 120 to 900° C.

14. The method according to claim 6, wherein the resulting particulate, water-insoluble inorganic material provided with silver oxide and ruthenium oxide is further processed to form a brightened particulate material having a brightness L* in the range of 50 to 85 by bringing it into contact with at least one C1-C4 alkoxide of aluminum, magnesium, calcium, silicon, zinc, zirconium and/or titanium in the presence of an amount of water that is at least sufficient for complete hydrolysis of the at least one C1-C4 alkoxide.

15. The use of the particulate, water-insoluble inorganic material provided with silver oxide and ruthenium oxide according to claim 1 as an additive for the antimicrobial treatment of metal surfaces; coating agents such as varnishes and other paints; plasters; molding compounds; plastics materials in the form of plastic films, plastics parts, or plastics fibers; textiles or textile applications; synthetic resin products; ion-exchange resins; silicone products; cellulose-based products; foams; and cosmetics or as a heterogeneous catalyst in the catalysis of the formation of hydroxyl radicals in aqueous media permitting bacterial growth.

16. The particulate, water-insoluble inorganic material provided with silver oxide and ruthenium oxide according to claim 2, wherein its silver-plus-ruthenium weight proportion formed by the silver oxide and ruthenium oxide is in the range of 0.1 to 50 wt. % at a simultaneously prevailing silver:ruthenium weight ratio in the range of 1 to 2000 parts by weight of silver:1 part by weight of ruthenium.

17. The method according to claim 7, wherein the silver oxide precursors and ruthenium oxide precursors are silver and ruthenium compounds, respectively, which can be thermally decomposed to form silver oxide and ruthenium oxide, respectively, in a non-reducing atmosphere.

18. The use of a product produced according to the method of claim 7 as an additive for the antimicrobial treatment of metal surfaces; coating agents such as varnishes and other paints;
plasters; molding compounds; plastics materials in the form of plastic films, plastics parts, or plastics fibers; textiles or textile applications; synthetic resin products; ion-exchange resins; silicone products; cellulose-based products; foams; and cosmetics or as a heterogeneous catalyst in the catalysis of the formation of hydroxyl radicals in aqueous media permitting bacterial growth.
